(19) United States
(12) Patent Application Publication
(10) Pub. No.: US 2021/0146969 A1
(43) Pub. Date: May 20, 2021

(54) ELECTRICALLY AND THERMALLY CONDUCTIVE THERMOPLASTIC POLYURETHANE

(71) Applicant: The Board of Regents of The University of Texas System, Austin, TX (US)

(72) Inventors: Constantine Tarawneh, Edinburg, TX (US); Robert Jones, Palmhurst, TX (US); Anthony Villarreal, Edinburg, TX (US); Harry Siegel, Mission, TX (US)

(21) Appl. No.: 17/097,450

(22) Filed: Nov. 13, 2020

Related U.S. Application Data
(60) Provisional application No. 62/934,588, filed on Nov. 13, 2019.

(51) Int. Cl. B61F 5/38; C09K 5/14; C08G 18/48; C08K 3/04; C08K 7/06

(52) U.S. Cl. CPC B61F 5/38; C09K 5/14; C08G 18/48; C08K 3/046; B29C 45/0001; C08K 2201/001; C08K 2201/011; C08K 2201/003; C08K 2201/004; C08K 7/06

(57) ABSTRACT

Described herein is an electrically and thermally conductive thermoplastic polyurethane. The conductive thermoplastic polyurethane is formed in an injection-molded process from vapor grown carbon nanofibers and a modified form of thermoplastic polyurethane (TPU). The polymer pad encompassing the injection-molded insert may be used to replace an existing railcar adapter pad.

### PRIORITY CLAIM

This application claims priority to U.S. Provisional Application Ser. No. 62/934,588 entitled “ELECTRICALLY AND THERMALLY CONDUCTIVE THERMOPLASTIC POLYURETHANE” filed Nov. 13, 2019, which is incorporated herein by reference in its entirety.

### STATEMENT REGARDING FEDERALLY SPONSORED RESEARCH OR DEVELOPMENT

This invention was made with government support under Grant No. DTRT 13-G-UTC59 awarded by U.S. Department of Transportation. The government has certain rights in the invention.

### BACKGROUND OF THE INVENTION

### Field of the Invention

The invention generally relates to electrically and thermally conductive polymers and uses thereof in railcar systems.

### Description of the Relevant Art

A railcar adapter pad (steering pad), shown in FIG. 1A, is a polymer component of a railcar that improves axle to rail wheelset alignment. The adapter pad is positioned between the bearing adapter and the side frame pedestal of the railcar. The adapter pad reduces stress on the axle and wear of the side frame pedestal. It does this by allowing each side of the wheelset to independently shift and adjust to the track as the railcar rounds a curve. The translation of the wheelset is transformed into deformation of the adapter pad, rather than a buildup of stress within the axle, and wear on mating surfaces when compared to standard metal bearing adapters. The pad is typically injection-molded using a thermoplastic polyurethane (“TPU”) due to the polymer's elasticity and durability. Two copper studs are molded into the pad to provide a conductive path for electrical signals to be passed via the rail in order to actuate loading devices on the car.

Because copper is a soft metal, the copper studs are easily deformed by cyclic loading and unloading of the car and abrasion from the shifting loads. If the copper studs experience excessive deformation or wear, they will lose continuity between the rail and the car, halting communications.

### SUMMARY OF THE INVENTION

In an embodiment, a conductive polymer pad comprises thermoplastic polyurethane and carbon nanofibers. The thermoplastic polyurethane may be present in an amount of about 70% to about 95% by weight. The thermoplastic polyurethane may be a polyether-based thermoplastic polyurethane.

The carbon nanofibers may be present in an amount of about 5% to about 25% by weight. IN an embodiment, the carbon nanofibers have an average diameter of between about 70 nm to about 200 nm. In an embodiment, the carbon nanofibers have an average length of about 50 microns to about 200 microns. The carbon nanofibers may be graphitic carbon nanofibers.

In an embodiment, the conductive pad has a resistance of less than 30 ohms. In an embodiment, the resistance of the conductive pad decreases as pressure on the conductive pad increases.

In an embodiment, a method of forming a conductive pad, as described herein, comprises: forming a mixture of a thermoplastic polyurethane and carbon nanofibers; and heating the mixture in a mold to form the conductive pad.

In an embodiment, a railcar adapter pad comprises a conductive polymer pad, the conductive polymer pad comprising thermoplastic polyurethane and carbon nanofibers.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1A depicts a projection view of an adapter pad;

FIG. 1B depicts a schematic representation of TPU;

FIG. 2A depicts a schematic representation of conductivity via tunneling;

FIG. 2B depicts a schematic representation of conductivity via direct contact;

FIG. 3A depicts a schematic diagram of an electrical conductivity test setup for a prototype pad;

FIG. 3B depicts a schematic diagram of a generic electrical conductivity test setup;

FIG. 4 depicts a circuit diagram of an electrical conductivity test;

FIG. 5 depicts a circuit diagram of a resistance determination circuit;

FIG. 6 depicts a voltage and current diagram for actuation of an air valve;

FIG. 7 depicts results of conductivity testing of injection-molded pucks;

FIG. 8A depicts a section view of an adapter pad;

FIG. 8B depicts an injection-mold insert;

FIG. 9 depicts 3D-printed epoxy molds with a 3D-printed cup (left) and a fractured part after pressing into the mold frame;

FIG. 10 depicts computer numerical controlled milled molds;

FIG. 11 depicts a diagram of the hot water circulation layout in a completed mold;

FIG. 12 depicts injection-molded inserts epoxied together;

FIG. 13 depicts conductive inserts pressed into an adapter pad;

FIG. 14 depicts the resistivity of a conductive polymer pad, under 1448 kPA applied stress, at various applied voltages;

FIG. 15 depicts the resistivity of a conductive polymer pad, at a voltage of 10V, under various applied stress;

FIG. 16 depicts the resistivity of a conductive polymer pad under longitudinal testing;

FIG. 17 depicts the resistivity of a conductive polymer pad under transverse testing;

FIG. 18 depicts X-Ray diffraction spectrum of various TPU composites;

FIG. 19 depicts an SEM image of TPU/CNF injected molded insert;

FIG. 20 depicts a DSC comparison of an injection-molded conductive polymer pad to a transfer-molded conductive polymer pad;

FIG. 21 depicts a DSC comparison of injection-molded inserts with and without CNFs;

FIG. 22 depicts the resistivity of a conductive polymer pad, at a voltage of 20V, under various applied stress;

FIG. 23 depicts the resistivity of a conductive polymer pad, under 1500 kPA applied stress, at various applied voltages;

FIG. 24 depicts the resistivity of a conductive polymer pad, under 3500 kPA applied stress, at various applied voltages; and

FIG. 25 depicts the resistivity of a conductive polymer pad, under 5500 kPA applied stress, at various applied voltages.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The examples herein are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

One solution to the problems with copper studded pads is to create a homogenous conductive material as a replacement for the current TPU pad. Such a material would allow electrical signals to travel through the entirety of the pad, instead of being limited to the small area previously occupied by the copper studs. In one embodiment, the problems associated with copper studs may be overcome by using a blend of carbon black (“CB”) and TPU to create a conductive composite material. The conductive composite material is intended to replace the standard TPU used in the railcar adapter pads. This material has exceptional electrical conductivity; however, it tends to have poor mechanical properties. In one test, a pad made of the CB/TPU material was placed in a freezer for eight hours then struck with a hammer. After three hits, one leg of the pad completely fractured off. It was believed that the carbon black tends to form agglomerates which act as stress risers in the material.

Another potential solution to this problem is to use carbon nanofibers as the conductive filler in a TPU matrix to create a conductive polymer composite. This material had adequate conductivity for the desired application of actuating a pneumatic valve, and improved mechanical stability when compared to the carbon black counterpart. However, this material failed to remain conductive when it was injection-molded. Based on the appearance of the neat TPU when injection-molded compared to the transfer-molded sample, it was hypothesized that the material did not maintain the same microstructure and therefore did not have the same electrical properties.

Described herein is an electrically and thermally conductive thermoplastic polyurethane. The conductive thermoplastic polyurethane is formed in an injection-molded process from vapor grown carbon nanofibers and a modified form of thermoplastic polyurethane (TPU). The injection-molded insert may be used to replace an existing railcar adapter pad.

Thermoplastic polyurethane (“TPU”) is a subgroup of a wider class of polymers called thermoplastic elastomers (“TPEs”). In general, TPEs are elastic materials that can be processed via standard thermoplastic manufacturing techniques such as injection-molding and extrusion. TPEs may be composed of both soft and hard segments. The soft segments are often compared to the matrix of a standard polymer composite, whereas the hard segments are compared to the filler or to the crosslinks seen in rubber materials. The two domains are incompatible at room temperature, however, upon melting, the soft and hard segments become homogenous. This leads to the material's favorable processability.

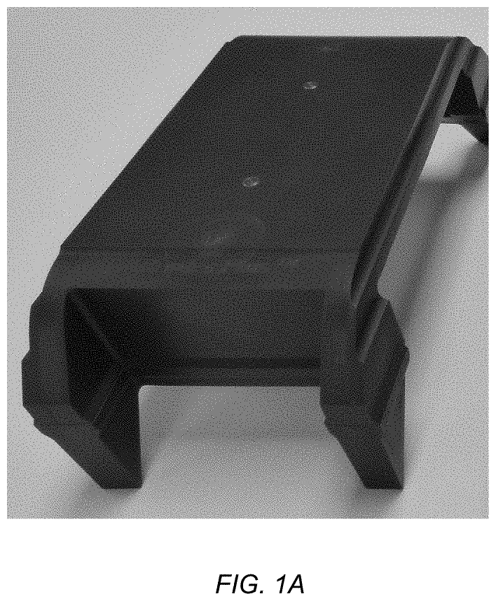

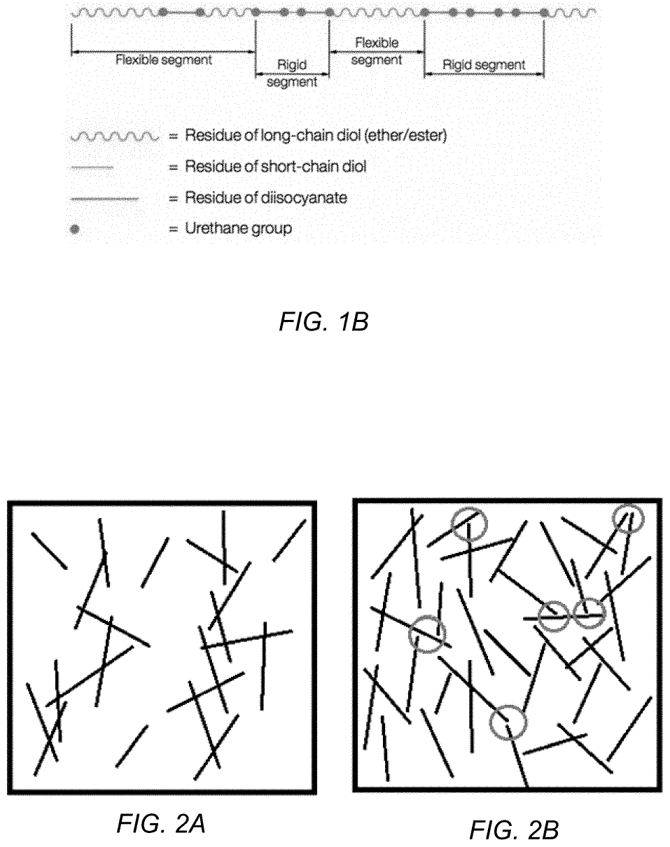

TPU is a block copolymer with alternating portions of soft segments, and hard segments. The viscoelastic and damping properties of TPU come from the long, flexible soft segments whereas the strength of the material comes from pinning and crosslinking effects of the hard segments that associate together and form pseudo-crystals to varying degrees, depending on the processing conditions. As previously mentioned, this creates two distinct phases, both a soft and hard phase, within the polymer. The separation of phases is what gives TPU its good wear performance and toughness, while maintaining a respectably high tensile strength. A schematic of TPU is given in FIG. 1B. In one embodiment, a polyether-based thermoplastic polyurethane is used, where the polyether group represents the “soft” or “flexible” segment.

Carbon nanofibers (“CNFs”) are one-dimensional, cylindrical shaped structures created by arranging layers of graphene, canted at a small angle, one on top of the other as stacked cups. This shape leads to extremely high length-to-diameter ratios, as well as surface area-to-volume ratio. Because the CNFs have such small volumes, they can be compounded into a polymer matrix without adding additional stress to the polymer backbone, which helps to maintain the mechanical properties of the matrix and therefore allow for efficient load transfer between matrix and fibers. Furthermore, the exposed edges of the CNFs can very easily be chemically, or thermally functionalized to improve chemical bonding between the CNFs and various matrices. Because of graphene's highly ordered structure, the CNFs made from them exhibit excellent mechanical properties, high electrical conductivity, and high thermal conductivity. The mechanical, electrical, and thermal properties of CNFs can be customized through various post production techniques.

In some embodiments, the CNFs have an average diameter of 70 to 200 nm. In some embodiments, the CNFs have an average length of 50 to 200 microns. In an embodiment, the CNFs may be heat treated before use to form graphitic CNFS. Graphite formation of the CNFs may be enhanced by coating CNFS with a layer of carbon through a deposition process. Heat treatment at temperatures up to about 3000° C. converts at least some of the coated CNFs to graphitic CNFs.

The two mechanisms of electrical conductivity within nanofiber networks are direct contact and tunneling, visually represented in FIG. 2. As the name suggests, in direct contact (FIG. 2A), the fibers in the matrix are physically touching end to end, forming conductive fiber chains throughout the matrix. The electrons are then able to travel down each active fiber chain, and out to the lower-potential side. High electrical conductivity composites can be created through direct contact conductive networks using relatively low fiber percentages, as well as minimal mixing, and therefore lead to a lower cost composite. However, conductive fiber networks formed via direct contact are susceptible to the formation of agglomerates within the polymer due to the need for physical contact of the fibers. The agglomerates act as cracks within the material and degrade mechanical properties. On the other hand, conductivity via tunneling occurs when fibers are within 10 nano meters of each other (FIG. 2B). At this distance, the material's potential well, the necessary energy an electron needs to tunnel, is small enough that an energized electron traveling along a fiber can tunnel or, in laymen's terms, “jump” to a neighboring fiber and continue to the zero-potential side. Conductivity via tunneling requires a relatively high percentage of fibers and a well-mixed composite blend, that leads to higher overall manufacturing costs. However, the improved mechanical properties of composites made in this fashion often make conductivity via tunneling the desired method of conductive network formation.

Potential alternatives to carbon fiber fillers are carbon black and metal fibers. Compared to carbon nanofiber composites, carbon black composites require a significantly higher concentration of filler to create a conductive material. This high concentration of carbon black often results in a material with low toughness and low wear resistance. Metal fibers are more often seen as a conductive filler in epoxy matrix composites, but are gaining use in standard thermoplastic materials. The challenges with metal fiber composites are that they are much heavier, more difficult to recycle, and can wear manufacturing equipment faster than the other fillers. To counteract the weight and wear issues, softer metals, such as silver, have been used to coat both glass and CNFs to improve the conductivity of the composite, without drastically increasing the weight, while being less abrasive on manufacturing equipment. A brief summary of the effect of the fiber filler on the thermoplastic composite is provided in Table 1.

TABLE 1
Comparison of fiber filler and general
corresponding composite properties

| | Carbon | Carbon | Carbon | Metal |
|---|---|---|---|---|
| | Black | Nanofibers | Fiber | Fiber |
| Composite | + | + | + | + |
| Stiffness | | | | |
| Composite | − | + | + | |
| Durability | | | | |
| Composite | + | + | | − |
| Processability | | | | |
| Filler/Fiber | + | − | | − |
| Cost | | | | |

### Electrical Resistivity Testing

Electrical resistivity of a material is a measure of how strongly that material resists the flow of electric current. Conversely, the electrical conductivity of a material is a measure of how easily the material allows the flow of electric current. The two material properties are inversely related. The electrical resistivity of a material can be experimentally determined using Equation (1).

$$ρ = R \frac{A}{L} \qquad ( 1 )$$

In the equation, p is the materials resistivity, R is the samples recorded resistance, A is the sample's cross-sectional area, and L is the length or thickness of the sample. Once a material's resistivity is determined, the resistance of any part made of that material can be determined.

Resistivity testing of the various composite samples was performed on a servo hydraulic material testing System (MTS 810) under a range of compressive loads and sample orientations. The loads were determined by comparing the cross-sectional area of the test specimen and applying a load that would stress the sample to a state within the range of what a railcar adapter pad would typically experience. Table 2 provides a list of sample loading scenarios for the conductive insert.

TABLE 2
Conductivity test loading conditions

| | | | | Single Insert | |
|---|---|---|---|---|---|
| Test | | | | Transverse | Longitudinal |
| Specimen | Prototype Pad | | | Direction | Direction |
| Load [lbs] | 1550 | 3550 | 5550 | 130 | 60 |
| Stress [psi] | 59 | 134 | 210 | 222 | 310 |
| Stress [kPa] | 405 | 926 | 1448 | 1530 | 2137 |

When fully loaded, a standard class F or K bearing will carry 34,400 pounds (153 kN). The railcar itself accounts for 17% of the total carrying capacity. Meaning, that when the car is unloaded, a bearing will still carry 5,848 pounds (26 kN). This equates to a maximum stress of 1,303 pounds per square inch and a minimum stress of 221 pounds per square inch seen by the top of the adapter pad. For the single inserts, all loads chosen in the experiments stress the samples to a state within that range. Previous studies have shown that increasing the compressive load generally has a positive impact on electrical conductivity of the material. Therefore, for the prototype pad, the worst-case scenario for the material conductivity occurs at the lowest stress state. The loads chosen for the prototype pad stress are more stringent than that seen in the field, which accounts for some potential manufacturing deviations.

Two distinct methods were used for applying an electrical charge to the system. For the preliminary injection-molded samples, the voltage was increased until a desired current of 270 milliamps was achieved. This method was used to determine whether the material was suitable for injection-molding into more complex geometries. For the tests thereafter, a constant potential difference of 5, 7.5, 10, 15, 20, and 24 volts was applied across the pad. In this case, various voltages were used to determine the electrical characteristics of the material for potential alternative applications, as well as to account for any inefficiencies or losses that may be seen in field use.

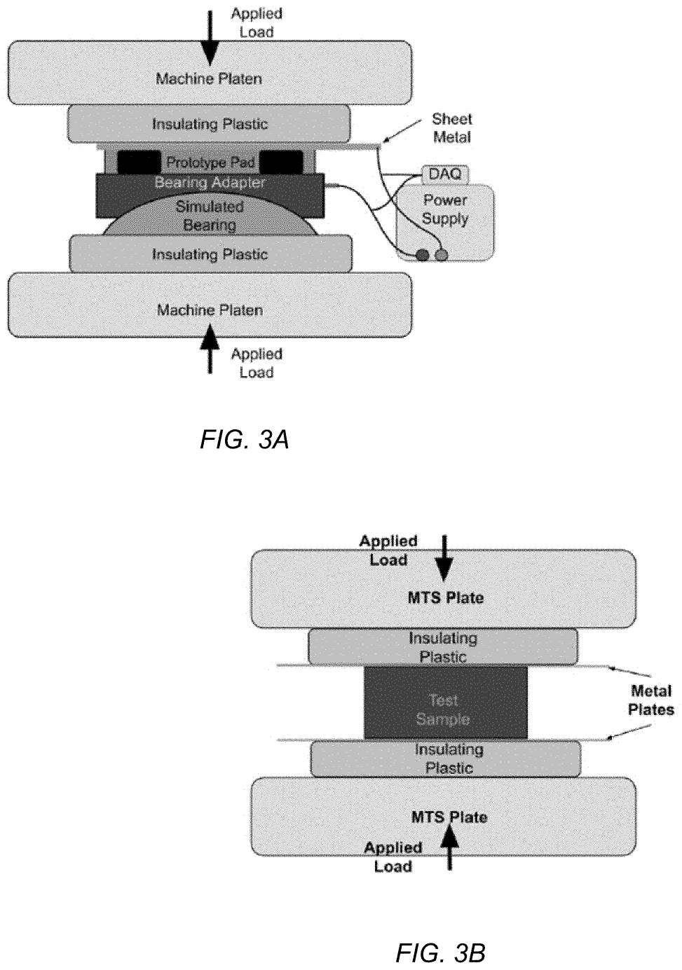

For all resistivity tests, the samples were isolated from the MTS compression platens using ½″ thick polymer sheets. For the prototype pad, a class F bearing cup (often referred to as the outer ring) was cut in half axially, and then welded to a′/4″ thick steel plate. This provided a flat surface for the MTS compression platens on one side, as well as a way to mount the bearing adapter on the opposite side. The cup was reinforced by welding half circle supports on the front and rear faces. A potential difference was applied to the system using a sheet of 20-gauge sheet metal on top of the prototype pad, and a bolt drilled into the bearing adapter. The load was then distributed to the top face of the prototype pad using an I-beam. A schematic of the test setup is shown in FIG. 3A. For resistivity testing of the initial pucks, transverse resistivity, and longitudinal resistivity, the voltage was applied to the system via two pieces of sheet metal on top and bottom of the test sample, as shown in FIG. 3B.

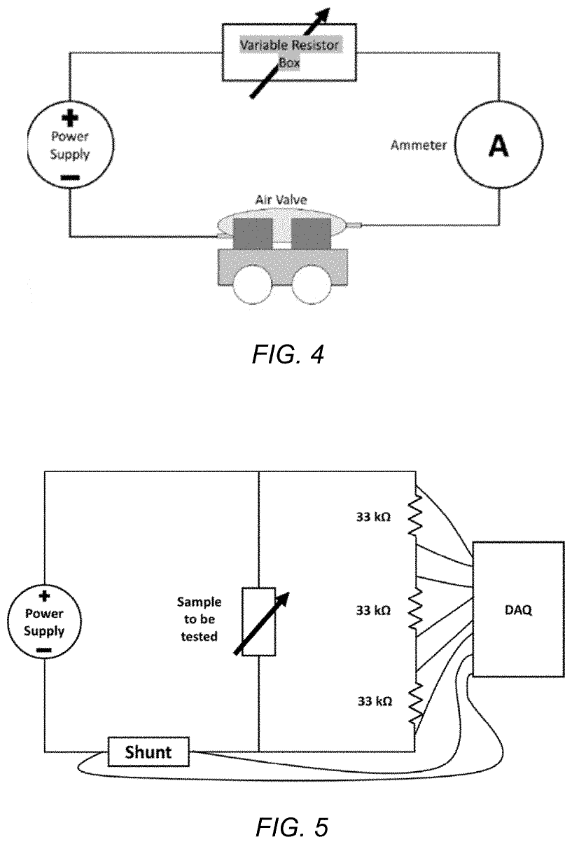

Once testing procedures had been developed, a target resistance could be determined. Two different tests were performed to accurately determine the resistance of the valve and the corresponding necessary resistance to achieve actuation. For the first test, an EMCO Resistance Decade Box was placed in series with the air actuator valve and a multimeter, and 24 volts were applied to the system. A schematic diagram of the setup is shown in FIG. 4. Starting at 40 ohms, the resistance of the box was manually decreased by 1 ohm increments until the air valve made an audible click. The voltage, current, and resistance were recorded, and the results are shown in Table 3. From this simple experiment, it could be determined that on average, a resistance of approximately 32 ohms or less is required to actuate the valve when 24 volts are applied to the system.

TABLE 3
Target resistance determination

| | Voltage | Current | Resistance |
|---|---|---|---|
| Test # | [V] | [A] | [Ω] |
| 1 | 24 | 0.23 | 33.10 |
| 2 | 24 | 0.23 | 32.00 |
| 3 | 24 | 0.23 | 31.10 |
| 4 | 24 | 0.23 | 31.10 |
| 5 | 24 | 0.23 | 33.00 |
| Average | 24 | 0.23 | 32.06 |

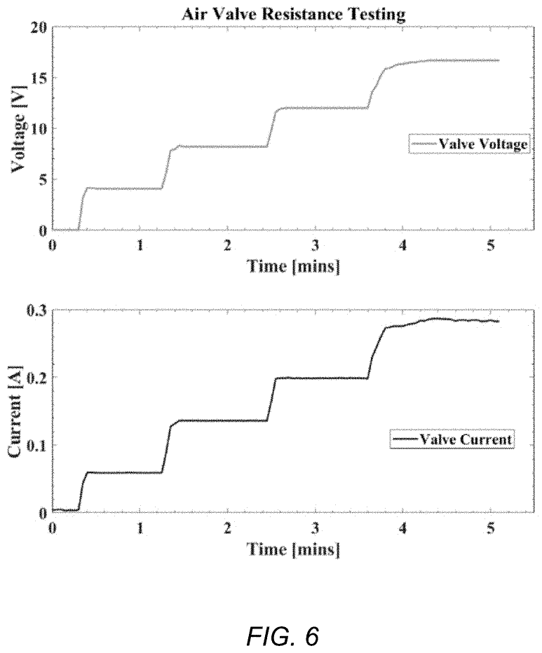

An alternative method of resistance determination involved placing the air actuation valve in the resistance determination circuit shown in FIG. 5. An initial potential difference of four volts was applied to the system. Then, the applied voltage was slowly increased in 4 volt increments until an audible click was heard, at which point the system was allowed to reach steady state. The corresponding data is shown in FIG. 6.

Using the data from the experiment, and Kirchhoff's Voltage Law, it was determined that the valve requires approximately 16.05 volts to achieve solo actuation. If 24 volts are typically applied to the system, that leaves a remainder of 7.95 volts potential difference available to the conductive adapter pad. Since the conductive pad and the actuation valve are in series, they must share the same current of 0.270 milliamps. Using these two variables and substituting into Ohm's law, it was determined that the necessary resistance of the prototype adapter pad must be less than 30 ohms for valve actuation. Compared to the initial target resistance of 32 ohms, the two target resistances agree to within 8 percent. For the experiments, an ideal resistance of 25 ohms, or less, was chosen, which allows just over 15 percent variance in resistance measurement. However, the 30-ohm resistance determined will also be represented in the figures as the maximum resistance. These resistances will be converted into corresponding resistivities, which depend on the dimensions of the tested samples. In all scenarios, an adequately conductive sample will have a resistivity below the target line. That is to say, that minimal resistivity equates to higher conductivity, which is desirable for valve actuation.

In order to accurately measure the resistance and current flow through the pad, a National Instruments (NI) USB-6008 data acquisition system (DAQ) programmed using LabVIEW™ was used along with a simple circuit that was developed. A schematic of the developed circuit and setup is shown in FIG. 5. A large 100 kilo-ohm total resistance was placed in parallel with the tested sample to ensure that the majority of the current flows through the sample. The 100 kilo-ohm resistance was broken into three legs of 33 kilo-ohm resistors so that the voltage drop across each resistor was in the allowable measurement range of the DAQ. The shunt resistor is small enough so that it allows the current through the system to be measured with negligible decrease to the voltage across the test sample. Using these values, any unknown resistance can be determined using a combination of Kirchhoff's and Ohm's laws. This setup allowed for continuous measurement of various samples and could detect small fluctuations in resistance over longer periods of testing.

X-ray diffraction is a type of X-ray spectroscopy that measures the intensity of a diffracted beam of X-rays to determine characteristics of a material such as crystal structure, chemical analysis, stress measurement, and more. For these experiments, X-ray diffraction was used to compare the crystal structure of TPU and TPU/CNF composites manufactured via transfer-molding and injection-molding. From the spectrums, a hypothesis can be made of how the differing pseudo-crystals affect carbon nanofiber networks and the resulting conductivity.

The Scanning Electron Microscope, commonly referred to by its initial's “SEM”, is used to obtain detailed, magnified images of small-scale samples. In order to prepare a sample for SEM imaging, the sample must occasionally be coated in a thin layer of gold, silver, or another type of conductive material via sputter coating. The conductive layer helps to attract the electron beam to the sample by grounding it. Without this conductive layer, electrons can build up on the surface of the test sample. The built-up electrons then repeal the electron beam and create blurry and poor-quality images. If the sample is metal or moderately conductive, sputter coating is not necessary. In the case of CNF/TPU composites, the sample was adequately conductive to not sputter-coat.

After the sample is prepared, the sample is placed in the test chamber. The test chamber is then vacuumed to evacuate any air or dust particles that may interfere with the beam of electrons. Finally, the samples are moved into place, and the electron gun is turned on. The computer is then used to decipher the signals received by the electron detectors and the SEM image is displayed.

Although typical use of the SEM involves imaging the surface of the sample, there is other information and insight that can be obtained by the SEM. For example, the elemental composition of the sample can be obtained via Energy Dispersive Spectroscopy (EDS). This technique involves monitoring the emitted photons generated by the electrons of the sample that are in the X-ray range.

For this analysis, the SEM will be used to verify the dispersion, the length, orientation, and the overall interaction of the TPU and carbon nanofibers within the injection molded samples. Samples were scored with a saw, along the areas of interest, then soaked in liquid nitrogen for 10 minutes. The samples were then removed, wrapped in tissue paper and put in a bag. The contained sample was then hit with a mallet to fracture. The sample was then removed, cleaned with isopropyl alcohol and a microfiber cloth before imaging in the SEM.

Differential Scanning Calorimetry (DSC) is a thermo-analytical technique that measures the amount of heat flow, either absorbed or generated, by a sample as it undergoes various thermal transitions. It does this by comparing the amount of heat required to raise the temperature of the sample to the amount of heat required to raise the temperature of an aluminum reference pan and plotting the curve as a function of temperature. In this study, the DSC was used to analyze the polymer morphology of injection-molded neat TPU, as well as injection molded composite CNF/TPU and determine the effects of the additional CNFs in the molding process. Also, comparisons between injection-molded samples and transfer-molded samples are made in an attempt to better understand how the different processing methods effect the conductivity of the nanocomposite.

A double run DSC was utilized to better understand the effects of the processing methods on the morphology of the material. In these tests, the material was heated at 2° C. per minute until 250° C. This heating rate gives an accurate response and minimizes noise, while the final temperature is just under the degradation range, 275° C. to 300° C., of the TPU. The material was then held at 250° C. for 5 minutes to ensure the entirety of the sample reached a uniform temperature and that any phase transitions had adequate time to be completed. Then the material was cooled at a rate of 5° C. per minute until it reached 60° C., at which point the sample was again re-heated at 2° C. per minute until 250° C.

### Injection-Molding Setup

The polymer used in this study was a modified Elastollan 1195a donated by BASF. This material had slightly altered hard segments that have a greater affinity for each other, although the full details of the modifications were not disclosed. The material was compounded with Pyrograf® III PR-19-HHT carbon nanofibers by Applied Sciences, Inc. As mentioned previously, prior injection-molded carbon nanofiber/TPU composite material was not electrically conductive, so an initial investigation was performed on the new material in order to determine the viability of this new composite for injection-molding conductive parts.

The material was first dried in an oven for four hours at 110° C. to remove any moisture. Test pucks were then injection-molded using a Boy 22A injection molding machine, with molding temperatures near the highest recommended range to minimize shear stresses in the melt to reduce the risk of fiber breakage. High molding temperatures are also hypothesized to be critical to the full development of pseudo-crystals in the TPU which maximize conductivity. The nozzle of the injection-molding machine was set to 227° C. and the remaining four zones were set to 204° C. The injection-molded parts were held in the mold for 90 seconds before being removed and allowed to cool to room temperature. The injection-molding parameters are summarized in Table 4 and Table 5.

TABLE 4
Injection-molding
temperature parameters
Temperature Parameters

| Mold | Nozzle | | | | |
|---|---|---|---|---|---|
| Temp | Temperature | Barrel 1 | Barrel 2 | Barrel 3 | Barrel 4 |
| [° C.] | [° C.] | [° C.] | [° C.] | [° C.] | [° C.] |
| 49 | 227 | 204 | 204 | 204 | 204 |

TABLE 5
Injection-molding parameters
Molding Parameters

| Shot | Shot | Mold | Total | Injection | Mold | Injection |
|---|---|---|---|---|---|---|
| Size | hold | Hold | Cycle | Speed | Clamping | Pressure |
| [mm] | [s] | [s] | [s] | [mm/s] | Force [N] | [kPa] |
| 38.5 | 10 | 90 | 100 | 55 | 890 | 13.8 |

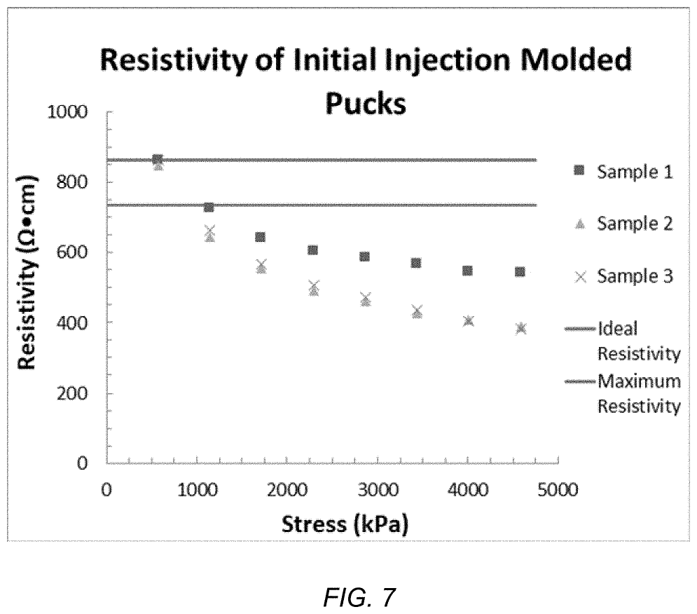

In total, 15 sample pucks were injection-molded. The first four pucks were discarded due to potential impurity from residual material in the barrel from previous use of the machine. The final injection molded pucks had an area of 19.4 cm², and a thickness of 0.66 cm. The samples were allowed to rest for 24 hours before subjected to conductivity testing. Three pucks with the fewest imperfections were tested for conductivity. The results are provided in FIG. 7. The resistivities corresponding to the ideal 25-ohm resistance, as well as the maximum 29.4-ohm resistance, respectively, are plotted in the figure for reference.

From the figure, it is apparent that at the 1500 kPa stress state, the samples maintained a resistivity that is below the maximum value which permits valve actuation. Meaning that all three pucks are conductive enough to actuate the valve at a stress of 1500 kPa or higher. It is also worth noting that the voltage necessary to achieve these resistances was in almost every instance less than the 7.5 volts which is typically available for the pad.

After it was determined that the new modified material could be adequately conductive when injection molded, an insert could be designed to incorporate into the adapter pad. From previous tests, it is known that maintaining load on the conductive composite is important for maintaining adequate conductivity. A pressure film study determined that the portion of the adapter pad that carries most of the load when the railcar is unloaded was at the interlocks. For this reason, conductive inserts were created with the same profile as the interlocks to ensure that the conductive portion of the prototype pad was constantly under load.

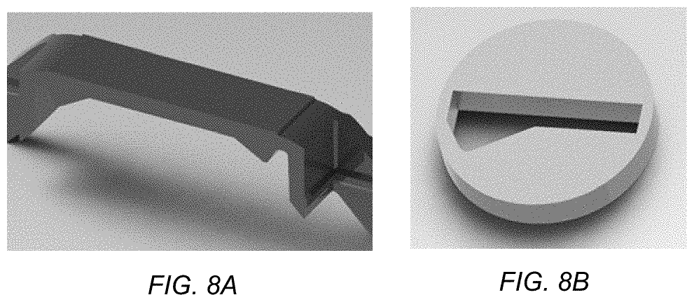

Using a computer model of the adapter pad, a profile of the interlocks was acquired by taking a section view of the model shown in FIGS. 8A and 8B. The mold was created by taking this profile and superimposing it over a cylinder of the same diameter and thickness as an existing mold cavity that was used as a frame to hold the new mold. The idea was to then bond the small inserts together side by side to create a part large enough to achieve sufficient electrical conductivity.

Validation by way of finite element analysis of this design was done using Autodesk Simulation Moldflow to determine problematic areas when injection molding, and SolidWorks™ Simulation to determine how the pad with new inserts would act under stress. The simulation was performed using both neat Elastollan 1195a for the fill properties, as well as Estaloc 59300 with 30% glass fiber for the fiber orientation analysis. Estaloc was chosen as it was the only fiber reinforced material in the system library which had molding parameters comparable to Elastollan. The portion of the insert that may potentially warp or not properly fill is the thickest portion at the interlocks, although the analysis still determines a fairly respectable 81.1 percent chance of molding correctly. This is likely to improve even more as carbon nanofibers have been shown to lock polymers in place and prevent excessive shrinkage or warping during molding. Regarding the fiber orientation analysis, the fibers in the middle of the part tend to align in the longitudinal direction, while the fibers at the edges of the insert tend to have a more random orientation. At the surface of the interlocks, the fibers are oriented parallel to the plane of the interlocks. However, towards middle of the interlocks, the fibers are slightly more vertically aligned. It is important to keep in mind fiber orientation of the part because carbon nanofibers are more conductive in the axial direction than they are in the radial direction. In industrial applications, the location of the gate may be modified to optimize the fiber orientation in the insert. However, for this study, due to limitations of the available tooling, the gate location was limited to the front face of the insert.

The parameters of the analysis are shown in Table 6. This analysis is a rough estimate of the effects of the insert on the integrity of the rest of the adapter pad. Some of the simplifications include the evenly distributed 34,400-pound load across the top of the pad, and the fixed condition of the bearing adapter. The largest stresses of about 10,500 kPa occur at the filleted edge of the pad and up to ½-inch towards the center. Beyond this area, the pad and insert have enough constraining material to essentially be considered under plane strain. There is a slight peel stress at the edges where the pad meets the insert, however, the deformations are minimal, and overall, the integrity of the pad is maintained.

TABLE 6
Mechanical finite element parameters

| Part | Material |
|---|---|
| Bearing Adapter | Plain Carbon Steel |
| Adapter Pad Plus | Elastollan 1195a |
| Adapter Pad | |
| Injection | Modified 1195a |
| Molded Inserts | w/ CNFs |
| Mesh Information | |
| Number of Elements | 72579 |
| Number of Nodes | 118284 |
| Boundary | |
| Conditions | |
| Bearing Adapter | Fixed on Axle |
| Contact Type | No Penetration |
| Load | 34,400 compressive |
| | evenly distributed |

### Mold Manufacturing

Once the design of the mold was complete, manufacturing could begin. During this step, it was important to balance both quality of mold and cost of the mold. Two different methods of mold manufacturing may be used.

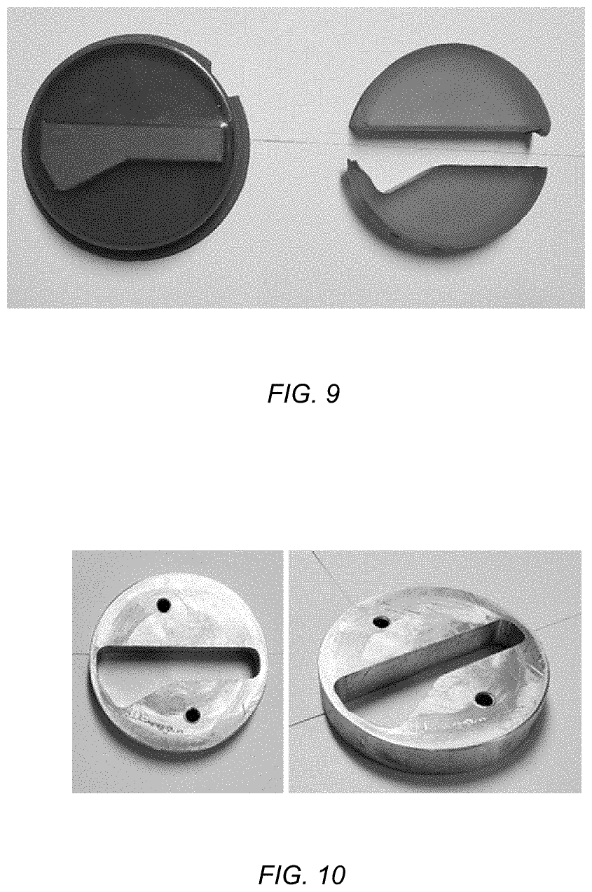

For one mold, a 3D-printed part was made that had the desired insert shape in the center of a ½-inch thick 4-inch diameter “cup”. The cup was then filled with Fibre Glast 2000 epoxy resin, stirring constantly, while heating the surface of the resin to remove any air bubbles in the pour. The resin was then allowed to cure for two full days. Once cured, the 3D-printed portions of the mold were removed. The final step was to press the epoxy mold into the mold frame. However, the epoxy mold was brittle and slightly oversized, and fractured while pressing it into the mold frame. The epoxy molds are shown in FIG. 9. Although the molds made in this manner were extremely cheap and suitable for the manufacture of the insert, they required long curing times, many post processing techniques, and maintained rough surface finishes from the 3D-printed material.

In another embodiment, a mold may be made via computer numerical controlled (CNC) mill. To do this, a 4.25-inch diameter rod of raw aluminum stock was machined to 3.996-inch diameter in the lathe and faced to the necessary ½ inch thickness. Next, two holes were drilled and tapped in the piece so that it could be mounted in the CNC mill. Lastly, the piece was centered in the CNC, and the desired shape was milled into the part. The part was then removed and pressed into the necessary frame for molding. The final machined mold is shown in FIG. 10. The resulting molds had a good surface finish.

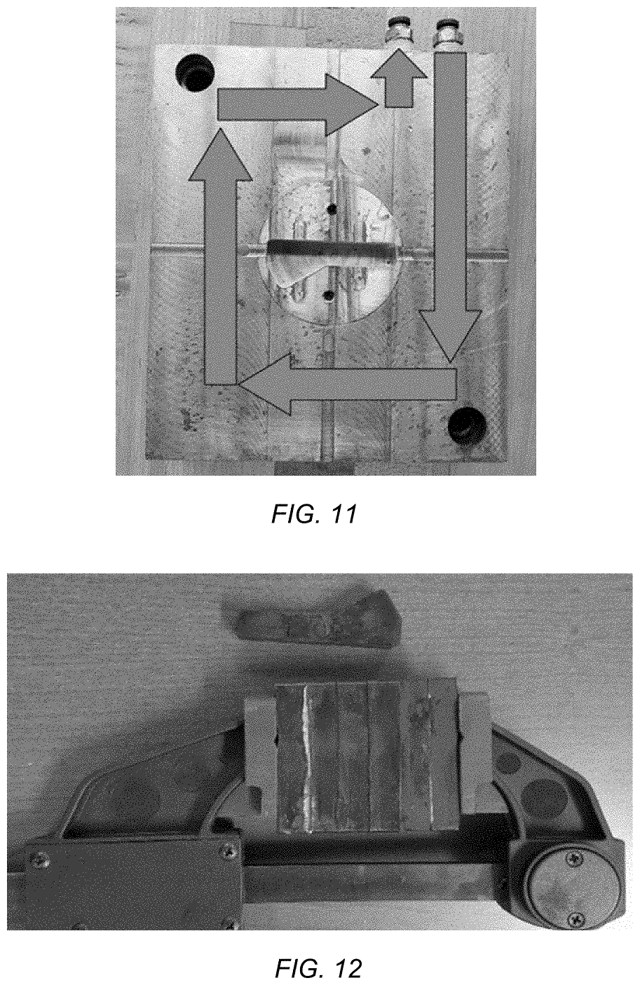

In order to manufacture quality parts, and to simulate actual manufacturing conditions, modifications to an existing mold housing were studied. Five holes, two on the top, two on the side, and one on the bottom, were drilled and tapped to allow for the circulation of heated water in order to maintain the mold at 40° C., required by the current adapter pad manufacturer. The CNC-manufactured aluminum mold was then pressed into the housing using a manual hydraulic press. Once the mold was pressed into the frame, eight gates were milled across the face of the assembly. These gates provide an escape for any air in the mold to be removed, as well as to allow a small amount of flashing to ensure the part is completely packed and filled, and to minimize shrinking or any other defects. The completed mold is shown in FIG. 11.

Prior to molding, the composite material was dried in an oven for four hours at 110° C. to ensure parts were free of moisture and to minimize defects. The inserts were made using a Boy 22A injection-molding machine using the parameters discussed in Table 4 and Table 5. The mold was held at a constant 40° C. throughout the molding process by means of a heated water circulation system.

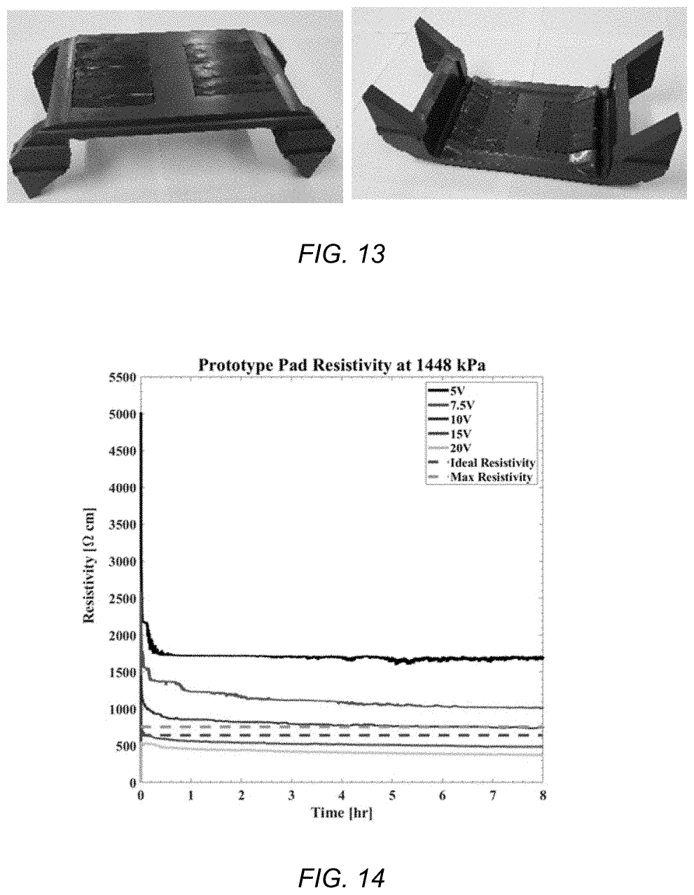

After molding, the parts were allowed to rest for 24 hours and were then epoxied together with a polyurethane compatible adhesive (JB Plastic Bonder) and bonded side by side. The bonding was done primarily to facilitate handling and installation of the parts and does not provide any additional structural integrity during pad loading. Throughout the curing phase, excess squeezed out adhesive was scraped off the top and bottom surfaces of the inserts to ensure that adhesive did not interfere with the conductivity of the parts. The assembled insert prototype is pictured in FIG. 12. The relevant section of a standard TPU pad was removed by milling and the assembled inserts were then bonded into the pad. The final prototype pad with conductive inserts is pictured in FIG. 13.

The prototype conductive pad is composed of two individual assemblies of seven inserts each. The combined area of the two inserts was 94.19 cm², with an average thickness of 3.648 cm. The recorded resistivity was determined by substituting the recorded resistance from the measurement system, along with the area and thickness values. The resulting values were then plotted in the figures. The two parameters explored in these experiments were the effect of load and voltage on material resistivity. In general, the shape of the graphs remains consistent throughout various loading and voltage scenarios. Like any system, the response of the prototype pad can be broken into its transient and steady state response. For the particular application of valve actuation, the steady state response is most important, due to the fact that once the bearing assembly is put into service, it is not removed, and the adapter pad is under load for the rest of its operating life. It is however interesting to examine the transient response for other potential applications.

FIG. 14 shows the effect that voltage has on material resistivity at 1448 kPa applied stress. Recall that this stress corresponds to the minimum stress seen by the adapter pad in normal operation. It can be seen that as the voltage increases, the resistivity of the material decreases at a decreasing rate. This means that as the applied voltage increases, the magnitude of these changes slightly diminishes. This is due to the potential well phenomenon discussed in section 1.4. In short, by increasing the applied potential to the system, the electrons traveling along the nanofiber networks have increased energy that enables them to tunnel over greater distances or barriers. Also, worth noting is the resistivity of the material at an applied potential difference of 7.5 volts. It was determined that the pad has approximately 8 volts available to it when in series with the 24-volt supply and air valve. This means that for the valve to actuate in operation, it requires a resistivity at 8 volts below the plotted “Target Resistivity” line. However, the figure does show that the pad could potentially actuate the valve if the available voltage to the pad could increase to approximately 12 volts. This would be possible if the voltage of the supply was increased, or if the resistance of the valve was decreased.

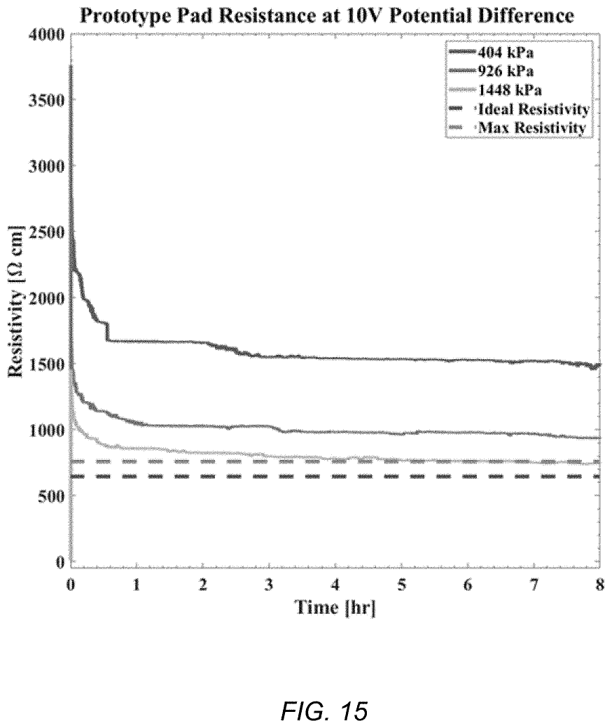

FIG. 15 explores the effect that load has on conductivity of the prototype pad. The overall response is similar to that seen in FIG. 14. As the applied stress, and corresponding strain, increases, the sample's resistivity decreases, or conversely the conductivity improves. This is believed to be due to the carbon nanofiber network physically moving closer together as the material is compressed. As this happens, the fiber networks develop more active branches as portions of fiber networks that were once separated either touch or become close enough to allow tunneling of electrons. Again, the effect of additional stress on the resistivity declines because there are a finite number of fiber networks that can be active within the composite and once those are all active, further reduction of fiber spacing does not yield significant improvements in conductivity. Furthermore, excessive loading has the potential to have a negative impact on the conductivity of the composite material. If the composite is loaded beyond its yield point, cracks may form that disrupt the conductive nanofiber networks within the matrix. Ultimately, the cracks would create voids and increase the distance between fiber networks, decreasing the number of active chains and decreasing composite conductivity. This particular phenomenon was not explored in these experiments, as all tests performed were well within the allowable stress range of the composite material, however it is worth noting.

As previously mentioned, the transient response is not as important for the function of the prototype adapter pad, however, it may prove to be a critical characteristic if the material is to be adapted for other applications such as an onboard load sensor. Various characteristics of the transient response are shown in Table 7, Table 8, and Table 9. These values were calculated by passing the resistivity data into the built-in MATLAB®. function “stepinfo( )” which calculates various characteristics of systems when a step input is applied.

TABLE 7
Max Resistivity

| Max Resistivity | | Applied Voltage [V] | | | | |
|---|---|---|---|---|---|---|
| [Ω · cm] | | 5 | 7.5 | 10 | 15 | 20 |
| Applied | 1448 | 5019 | 2590 | 1456 | 1082 | 556 |
| Stress | 926 | 14953 | 19259 | 3762 | 1157 | 852 |
| [kPa] | 404 | 15524 | 20857 | 3238 | 2498 | 1696 |

TABLE 8
Percent Overshoot

| Percent | | Applied Voltage [V] | | | | |
|---|---|---|---|---|---|---|
| Overshoot | | 5 | 7.5 | 10 | 15 | 20 |
| Applied | 1448 | 196 | 155 | 93.97 | 123 | 48 |
| Stress | 926 | 121 | 620 | 301 | 110 | 129.6 |
| [kPa] | 404 | 373 | 196.6 | 117 | 190 | 155 |

TABLE 9
Settling Time

| 95% Settling | | Applied Voltage [V] | | | | |
|---|---|---|---|---|---|---|
| Time [hr] | | 5 | 7.5 | 10 | 15 | 20 |
| Applied | 1448 | 0.3 | 4.2 | 4.6 | 4.3 | 5.6 |
| Stress | 926 | 4.7 | 1.5 | 0.8 | 5.0 | 3.6 |
| [kPa] | 404 | 0.007 | 5.7 | 2.7 | 3.2 | 4.8 |

There are a few characteristics of the material that can be determined from Table 7, Table 8, and Table 9. First is that, in most instances, increasing the applied voltage decreases the percent overshoot of the resistivity. Again, this is likely attributed to the potential energy needed for an electron to tunnel. By exciting the system with higher voltage, the electrons in the system more quickly acquire enough energy to tunnel, which decreases the large initial resistance. Second is that, the settling times vary from 0.007 hours to as high as 5.7 hours. This is due to continuous creep of the material, which is a problem when working with any thermoplastic, as the MTS hydraulic press applies a constant load to the system. As the material continues to creep, the resistivity slightly decreases over long periods of time. However, in this carbon nanofiber composite, the virtual crosslinks of the polymer's hard domains, and pinning effect of the nanofibers help to limit creep of the composite.

Perhaps the most important characteristic of the prototype pad is its steady state resistance. These values were determined by averaging the resistivity values of the material over the last four hours of testing. The results are shown in Table 10. These values reiterate the general trends seen throughout the experiments. That is, increasing the applied load, and therefore stress on the material, as well as increasing the applied voltage decreases the resistivity of the material.

TABLE 10
Steady State Resistance

| Steady State | | Applied Voltage [V] | | | | |
|---|---|---|---|---|---|---|
| Resistivity [Ω cm] | | 5 | 7.5 | 10 | 15 | 20 |
| Applied | 1448 | 1684 | 1039 | 763 | 500 | 390 |
| Stress [kPa] | 926 | 6774 | 2776 | 969 | 568.5 | 381 |
| | 404 | 14959 | 8034 | 1528 | 889 | 694 |

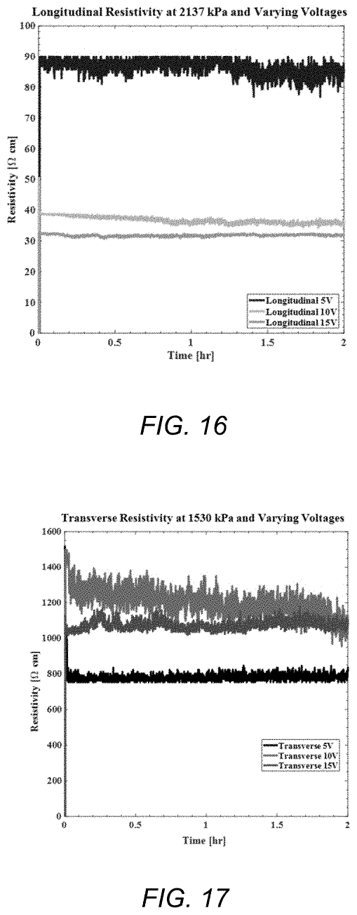

For longitudinal and transverse testing, the interlock portion of an injection-molded insert was removed. The sample was then loaded and tested along each axis. The results of the conductivity tests are presented in FIG. 16 and FIG. 17.

Comparing the two figures, there is quite a significant difference in electrical resistivity of the material depending on the direction that is being tested. We can see that in the longitudinal direction, the resistance of the material is an entire order of magnitude less than in the transverse direction. From the mold flow simulation, it is expected that the fibers in this location have a relatively strong alignment in the longitudinal direction. Studies have shown carbon nanofibers to be significantly more conductive along their axis, compared to the transverse direction. This alignment of nanofibers compounded with the fact that the fibers themselves are more conductive in that particular direction is what caused the significant decrease in resistivity. Furthermore, although the loading face and condition was slightly different, the resistivity for the transverse direction is near the conductivity of the prototype pad. This is expected since in both scenarios the load and potential difference is being applied normal to the axis of the expected alignment of the CNFs.

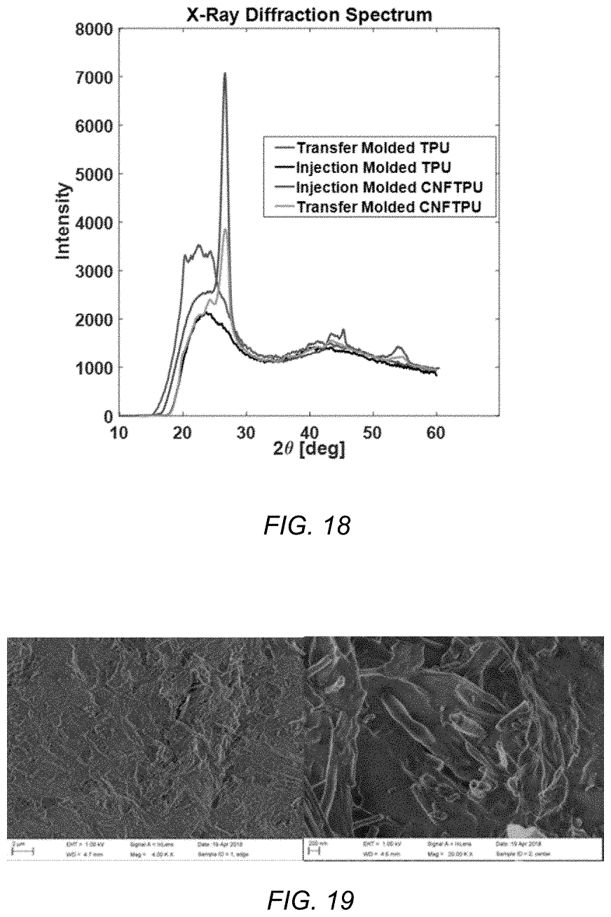

As previously mentioned, various samples were examined using X-ray diffraction spectroscopy in hopes of characterizing the hard domains, identifying differences in the material morphology, and estimating how these differences affect the composites resistivity as a whole. The results of the tests are shown in FIG. 18.

From left to right, the first broad hump seen in all the samples is centered at approximately 2θ=22.5° and is characteristic of the BASF Elastollan TPU used in these experiments. This broad peak arises from the general association of hard segments within the TPU and is typical of most amorphous solids. There are however distinct differences in the smoothness of each spectrum.

That is, the samples that were created via transfer-molding are distinctly rougher than their injection-molded counterparts. In fact, the transfer-molded samples both have two additional small peaks at 2θ=20.3° and 2θ=24.3°, respectively. These peaks are believed to be related to additional spherulites that are able to grow off the main hard segments as a result of the slow cooling rate seen by the transfer-molded samples. Specifically, the slow cooling rate allows the hard segments within the polymer the time and energy necessary to concentrate and form more distinct pseudo-crystals. Also, recall that the injection-molded CNF/TPU was mixed by Applied Sciences, Inc using a modified version of the Elastollan 1195a with slightly different hard domains, as well as their proprietary mixing procedure for conductive composites. The effect of the modified Elastollan can be seen by the larger magnitude of the broad peak when compared to both the transfer-molded composite, as well as the injection-molded neat Elastollan 1195a.

The peaks on both CNF/TPU curves are characteristic of the carbon nanofibers used as conductive fillers within the polymer. Both samples were compounded with Pyrograf® PR-19-XT-HHT carbon nanofibers and have a peak centered at 2θ=26.6°. However, there is a significant difference in the magnitude of the peaks. One likely explanation for this is that in the conductive transfer-molded parts, the pseudo-crystals associated with the 24.3° peak grew on and around the CNFs. This is seen in the figure as the slight overlap of the ends of the two distinct peaks. This interaction potentially weakened both the energy of the incoming X-rays, as well as the energy of the refracted X-rays.

The hard domains act as virtual crosslinks within the polymer. It is suspected, that when interlocked with the carbon nanofibers, they are able to limit movement not only of the soft segments, but also of the fibers as well. This makes it more likely that fiber chains come into contact with each other under compressive loads rather than flow past each other with the polymer. This may be the reason that the transfer-molded composites tend to have enhanced electrical conductivity compared to the injection-molded samples.

Images from the scanning electron microscope are shown in FIG. 19. The left image shows good dispersion of nanofibers throughout the sample with no visible agglomerations. Also, it can be observed that many of the fibers were able to maintain the relatively long lengths, on average between 5 μm and 7 μm, even through the shear intensive injection-molding process. There is also a preferred orientation of the fibers. The first sample, being from the edge of a molded insert, has an orientation that is aligned with the plane of the mold as expected. However, the right image taken from the middle of the insert, also shows a tendency for the fibers to have a slightly preferred orientation. This subtle orientation is similar to what was expected in the center of the inserts as predicted by the mold flow analysis. Also apparent from the right image is the good wetting of fiber by the polymer, as each fiber is completely embedded in polymer.

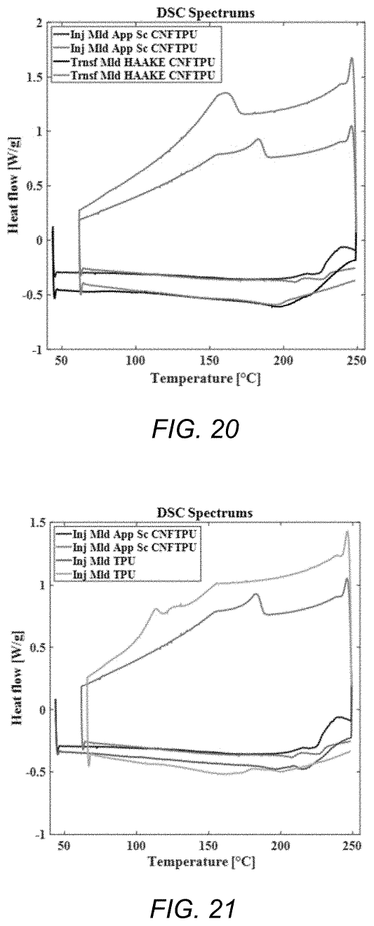

The test method for the DSC experiments performed was outlined above, but in short, a double run was utilized to determine the effects of processing conditions on the morphology of the samples. A DSC comparison of the injection-molded insert to the transfer-molded pucks is presented in FIG. 20.

For the injection-molded sample, there does not appear to be any indications of a melt during the first run. The first significant change is a relatively large broad hump centered at about 240° C. This hump is not repeated during the second run, so it is believed that this hump is caused by the composite material relaxation of molded-in strain relaxing when the temperature permits large scale molecular motions. CNFs can act as pinning points within the polymer matrix. In this case, there is a small amount of residual stress that resulted from a combination of the pinning effects as well as the rapid cooling of the insert in the injection mold. For the transfer-molded sample, there appears to be a small valley at 195° C. that is associated with the melting point of the pseudo-crystals, as it is seen again on the second run. Again, there is an exotherm that is related to the stress relaxation, however, since the transfer-molded samples are already cooled at a relatively slow rate, this reaction has a lesser magnitude than for the injection-molded sample. Following the first ramp up, the sample is cooled (upper portion of the curve). In both composites, there is a crystallization peak. For the injection-molded material this is near 180° C., and for the transfer-molded material there is a larger peak centered at 160° C. A higher crystallization temperature is typically desired for injection-molding processes so that material does not have to be held in the mold as long, reducing cycle times. In the second heating run, there is a small double melt for the injection-molded sample, and a very similar melt for the transfer-molded sample. Lastly, both stress relaxation reactions shown in the first run are greatly reduced in both samples during the second run. This would be expected since the second run samples were cooled at extremely low rates, producing a near equilibrium molecular arrangement.

FIG. 21 compares the morphology of the injection-molded conductive inserts against the injection-molded neat Elastollan 1195a. The neat Elastollan 1195a appears to have formed just slightly more pseudo-crystals in the molding process than the material with the CNFs as indicated by the two subtle dips near 200° C. on the first run. This appears to be in contrast with the results of the XRD testing. One possible explanation is that the Elastollan 1195a, used to make the conductive composites, had a larger association of hard segments, that is hard segments that are physically closer together indicated by the large hump in the XRD spectrum, but the standard Elastollan 1195a had more ordering of the hard segments, as indicated by the much rougher XRD scan.

### CONCLUSIONS

A conductive polymer composite was prepared via injection-molding using a modified Elastollan 1195a TPU that had hard segments that would associate at lower temperatures, as well as minimizing the shear on the polymer and fibers when injection-molding. The effect of load and applied potential difference on the resistance of the material, as well as the difference in morphological structure between injection-molded and previously transfer-molded samples, was examined. A prototype adapter pad was created by removing a section of a adapter pad and inserting an injection-molded part made of a blend of 15 weight percent carbon nanofibers and 85 weight percent modified Elastollan 1195a (TPU).

The electrical conductivity tests show that between 0 and 926 kPa of applied stress, the resistivity of the prototype pad decreases as the applied load on the pad increases. Above 926 kPa, increasing stress appears to have a diminishing effect on resistivity. Also analyzed in this study was the effect of voltage on the resistivity of the material. It was shown that the resistance has a non-linear dependence on the voltage, specifically, as the applied potential difference increases, the resistance of the material decreases. This is consistent with conductivity by percolation rather than direct contact and indicates that the fiber dispersion was very good.

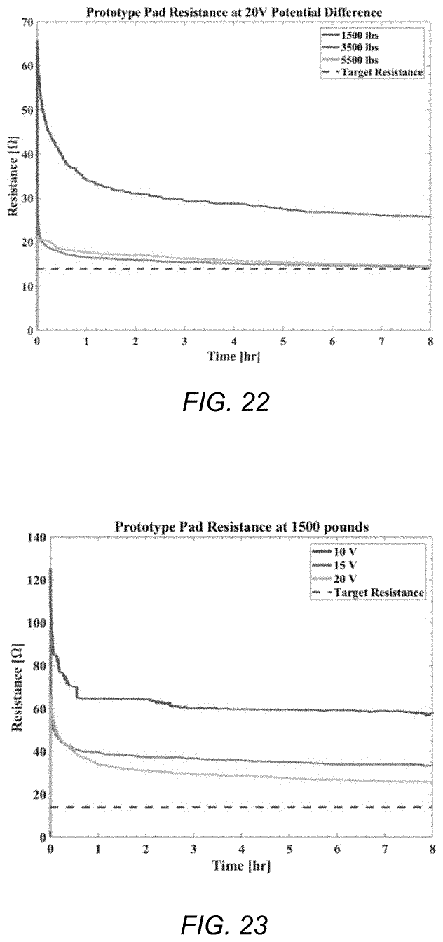

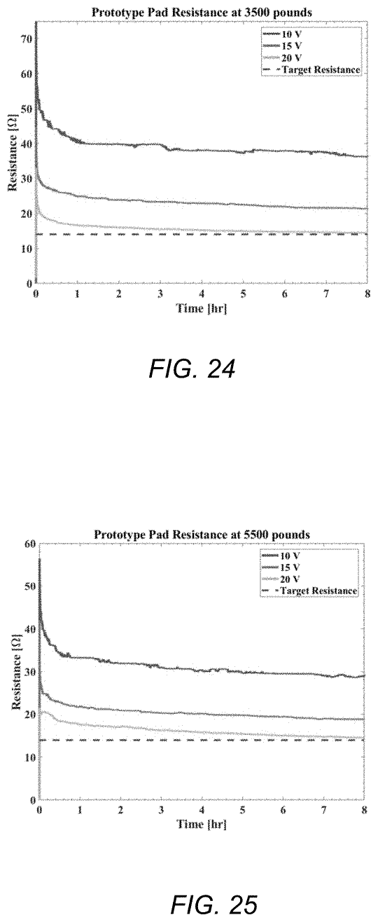

It is interesting to note that the initial resistance of the pad when it is first loaded can be nearly twice the steady-state value. FIG. 22 depicts resistance change over time for a prototype pad with a 20-volt potential difference at various applied loads. FIG. 23 depicts resistance change over time for a prototype pad at various potential differences at an applied load of 1500 pounds. FIG. 24 depicts resistance change over time for a prototype pad at various potential differences at an applied load of 3500 pounds. FIG. 25 depicts resistance change over time for a prototype pad at various potential differences at an applied load of 5500 pounds. Table 11 summarizes this data, comparing the steady state resistance to the applied voltage. Depending on the loading and voltage conditions, the settling time can vary from as little as 0.6 hours at high potential difference and high loads to nearly 1.5 hours at low potential differences and low loads. However, in practice, the pad will only see a zero load if the railcar itself momentarily loses contact with the wheel-axle assembly as a result of a significant bump in the rail tracks, so settling time will not be a major concern in actual rail service. Furthermore, the high initial resistance is likely due to surface resistance between the pad and metal fixtures.

TABLE 11

| Steady State | | Applied Voltage [V] | | |
|---|---|---|---|---|
| Resistance [Ω] | | 10 | 15 | 20 |
| Load [lb] | 1500 | 58.9 | 34.1 | 26.4 |
| | 3500 | 37.5 | 21.8 | 14.7 |
| | 5500 | 29.4 | 19.2 | 15.0 |

Longitudinal and transverse conductivity tests demonstrated that there is an order of magnitude difference in conductivity depending on the preferred orientation of carbon nanofibers within the sample. One way to improve conductivity of the prototype pad is to optimize gate placement so that the fibers in the injection molded part are relatively aligned with the direction of the desired flow of electrical current.

From X-ray diffraction testing, it was seen that the injection-molded sample and the transfer-molded sample have similar overall morphological structure. However, the diffraction curve of the transfer-molded sample is slightly rougher, which suggests variations of hard segments within the polymer. Also, the nanofiber peak of the injection-molded sample is much larger than that of its transfer-molded counterpart. It is believed that this suggests slightly more alignment of nanofibers in the composite part.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A conductive polymer pad comprising thermoplastic polyurethane and carbon nanofibers.

2. The conductive polymer pad of claim 1, wherein the thermoplastic polyurethane is present in an amount of about 70% to about 95% by weight.

3. The conductive polymer pad of claim 1, wherein the thermoplastic polyurethane is a polyether-based thermoplastic polyurethane.

4. The conductive polymer pad of claim 1, wherein the carbon nanofibers are present in an amount of about 5% to about 25% by weight.

5. The conductive polymer pad of claim 1, wherein the carbon nanofibers have an average diameter of between about 70 nm to about 200 nm.

6. The conductive polymer pad of claim 1, wherein the carbon nanofibers have an average length of about 50 microns to about 200 microns.

7. The conductive polymer pad of claim 1, wherein the carbon nanofibers are graphitic carbon nanofibers.

8. The conductive pad of claim 1, wherein the conductive pad has a resistance of less than 30 ohms.

9. The conductive pad of claim 1, wherein the resistance of the conductive pad decreases as pressure on the conductive pad increases.

10. A method of forming a conductive pad comprising:
forming a mixture of a thermoplastic polyurethane and carbon nanofibers;
heating the mixture in a mold to form the conductive pad.

11. The method of claim 10, wherein the thermoplastic polyurethane in the mixture is present in an amount of about 70% to about 95% by weight.

12. The method of claim 10, wherein the thermoplastic polyurethane in the mixture is a polyether-based thermoplastic polyurethane.

13. The method of claim 10, wherein the carbon nanofibers in the mixture are present in an amount of about 5% to about 25% by weight.

14. The method of claim 10, wherein the carbon nanofibers in the mixture have an average diameter of between about 70 nm to about 200 nm.

15. The method of claim 10, wherein the carbon nanofibers in the mixture have an average length of about 50 microns to about 200 microns.

16. The method of claim 10, wherein the carbon nanofibers in the mixture are graphitic carbon nanofibers.

17. The method of claim 10, wherein the conductive pad has a resistance of less than 30 ohms.

18. The method of claim 10, wherein the resistance of the conductive pad decreases as pressure on the conductive pad increases.

19. A railcar adapter pad comprising a conductive polymer pad, the conductive polymer pad comprising thermoplastic polyurethane and carbon nanofibers.

20. The railcar adapter pad of claim 19, wherein the thermoplastic polyurethane is present in an amount of about 70% to about 95% by weight.

21. The railcar adapter pad of claim 19, wherein the thermoplastic polyurethane is a polyether-based thermoplastic polyurethane.

22. The railcar adapter pad of claim 19, wherein the carbon nanofibers are present in an amount of about 5% to about 25% by weight.

23. The railcar adapter pad of claim 19, wherein the carbon nanofibers have an average diameter of between about 70 nm to about 200 nm.

24. The railcar adapter pad of claim 19, wherein the carbon nanofibers have an average length of about 50 microns to about 200 microns.

25. The railcar adapter pad of claim 19, wherein the carbon nanofibers are graphitic carbon nanofibers.

26. The railcar adapter pad of claim 19, wherein the conductive pad has a resistance of less than 30 ohms.

27. The railcar adapter pad of claim 19, wherein the resistance of the conductive pad decreases as pressure on the conductive pad increases.
